(19) United States
(12) Patent Application Publication
(10) Pub. No.: US 2005/0175378 A1
(43) Pub. Date: Aug. 11, 2005

(54) Developing apparatus

(75) Inventor: Momomi Aoki, Gose-shi (JP)

Correspondence Address: NIXON & VANDERHYE, PC, 901 NORTH GLEBE ROAD, 11TH FLOOR, ARLINGTON, VA, 22203, US

(73) Assignee: Sharp Kabushiki Kaisha, Osaka (JP)

(21) Appl. No.: 11/046,732

(22) Filed: Feb. 1, 2005

(30) Foreign Application Priority Data
Feb. 9, 2004 (JP) 2004-032335

(51) Int. Cl. G03G 15/08

(52) U.S. Cl. 399/284

(57) ABSTRACT

A developing apparatus includes a container for containing developer including toner; a developer supporting body, which is elastic and provided so as to contact an image supporting body, for supplying the developer to the image supporting body; and a developer amount controlling blade, which is attached to the container so as to contact the developer supporting body, for controlling an amount of toner supplied. The developer amount controlling blade has, at least in a region that contacts the toner, a composite plated film containing fine particles of fluorocarbon resin. It is preferable that the composite plated film is not thinner than 1 μm and not thicker than 15 μm. With this arrangement, it is possible to provide a developer amount controlling blade that is free, even after prolonged use, from image deterioration caused by melt and adhesion of the toner, and therefore has a long life.

This nonprovisional application claims priority under 35 U.S.C. § 119(a) on Patent Application No. 032335/2004 filed in Japan on Feb. 9, 2004, the entire contents of which are hereby incorporated by reference.

### FIELD OF THE INVENTION

The present invention relates to a developing apparatus used in electrophotographic image formation for developing and visualizing a latent image formed on an image supporting body, and relates in particular to a developing apparatus including a blade member for controlling the amount of developer.

### BACKGROUND OF THE INVENTION

One of the conventionally known development methods using an electrophotographic process is impression development. The impression development is advantageous in many respects. For example, a developing apparatus using the impression development can be simplified and miniaturized easily, and can easily have high resolution. In this developing method, it is necessary to form a thin layer of developer on a developer supporting body. This layer is approximately a single layer. In general, a developer amount controlling blade is used as developer amount controlling means, and is pressed against the developer supporting body so as to form an even and thin toner layer. The developer amount controlling blade not only controls the amount of toner on the developer supporting body, but also electrically charges the toner by friction. In many cases, the developer amount controlling blade is a thin plate made of stainless steel or the like metal, and is shaped by punching or etching. One advantage of using stainless steel or the like metal is that a temperature change does not influence the pressure against the developer supporting body.

However, if the developer amount controlling blade is used, the amount of toner is controlled by relatively high pressure. This causes the problem that, after a long period of time, the toner melts and adheres to the developer amount controlling blade, due to friction and impression stress.

Recently, with the improvement of image quality and the use of full colors through application of the electrophotographic process, toner tends to have small particle diameters, and the toner layer on the developer supporting body needs to be thinner. Moreover, from the viewpoint of fixability in the case of full color, the melting point of toner needs to be lower. Under such a circumstance, melt and adhesion of the toner is accelerated, and deterioration of images (e.g. appearance of white lines) is more likely to occur.

As a means for solving these problems, Patent Publication 1 (Japanese Publication for Laid-Open Patent Application, Tokukaihei 10-142934, published on May 29, 1998), for example, proposes to provide a toner-releasing layer made of such a material as silicone or fluorocarbon resin in the region were the developer amount controlling blade and toner contact each other. Meanwhile, Patent Publication 2 (Japanese Publication for Laid-Open Patent Application, Tokukai 2001-194896, published on Jul. 19, 2001) proposes a developer controlling blade having a composite plated layer of nickel and phosphorus, in which fine particles of fluorocarbon resin are dispersed at a portion that contacts the developer supporting body.

However, in the developer amount controlling blade having the silicone or fluorocarbon resin layer, the amount of charge and the polarity of charge of the toner particles easily become uneven. As a result, adhesion of toner to a base portion of an image (a so-called fog effect) is likely to occur. If the developer amount controlling blade having the silicone or fluorocarbon resin layer is pressed against the developer supporting body at a high contact pressure, the resin layer could be worn or peeled off after a prolonged use. There are cases where, in the plated layer in which the fine particles of fluorocarbon resin are dispersed, the plated layer and the fine particles of fluorocarbon resin are peeled off or separated depending on the thickness of the plated layer, the amount of the plated layer, or the size of the fine particles of resin, for example, thereby making it impossible to attain desired effects in terms of toner releasability and a resistance property to melt and adhesion of toner.

It is inferred that the melt and adhesion of the toner due to prolonged use of the developer amount controlling blade occurs as follows. First, fine or deteriorated toner is fixed and agglomerated to the tip portion of the developer amount controlling blade. Then, due to frictional heat and impression stress between the developer amount controlling blade and the developer supporting body, the toner is denatured, melted, and adhered. Therefore, in order to prevent the melt and adhesion of the toner, it is necessary to prevent fixation of the toner to the tip portion of the developer amount controlling blade.

### SUMMARY OF THE INVENTION

The present invention was made to solve the foregoing problems. An object of the present invention is to provide a developer amount controlling blade that is free, even after prolonged use, from image deterioration caused by melt and adhesion of toner, and therefore has a long life.

To solve the foregoing problems, a developing apparatus of the present invention includes: a container for containing developer including toner; a developer supporting body, which is elastic and provided so as to contact an image supporting body, for supplying the developer to the image supporting body; and a developer amount controlling blade, which is attached to the container so as to contact the developer supporting body, for controlling an amount of developer supplied, the developer amount controlling blade having, at least in a region that contacts the toner, a composite plated film containing fine particles of fluorocarbon resin.

It is preferable that, in addition to having the foregoing arrangement, the developing apparatus of the present invention satisfies the following conditions (a) to (c):
(a) The composite plated film is not thinner than 1 μm and not thicker than 15 μm;
(b) The fine particles of fluorocarbon resin has a diameter not smaller than 0.1 μm and not larger than 5 μm; and
(c) The fine particles of fluorocarbon resin in the composite plated film has a volume percentage not lower than 20% and not higher than 35%.

According to the present invention, the developer amount controlling blade has, at least in a region that contacts the toner, a composite plated film containing fine particles of fluorocarbon resin and having excellent toner releasability. By optimizing the thickness of the film, the size of the fine particles, and the volume percentage of the fine particles of resin contained, the effect of the composite plated film can be maximized. This prevents melt and adhesion of the toner to the surface of the blade for a long time. Therefore, it is possible to provide a developing apparatus having high image quality and long life.

For a fuller understanding of the nature and advantages of the invention, reference should be made to the ensuing detailed description taken in conjunction with the accompanying drawings.

### BRIEF DESCRIPTION OF THE DRAWINGS

FIG. 1 is a cross-sectional view illustrating a schematic arrangement of a developing apparatus in accordance with one embodiment of the present invention.

FIG. 2 is a cross-sectional view illustrating a developer amount controlling blade provided to the developing apparatus of FIG. 1.

FIG. 3 is a table showing conditions of the developer amount controlling blade in EXAMPLES.

FIG. 4 is a table showing conditions of the developer amount controlling blade in COMPARATIVE EXAMPLES.

FIG. 5 is a table showing a result of evaluation of a resistance property of the developer amount controlling blade against melt and adhesion, in EXAMPLES and COMPARATIVE EXAMPLES.

### DESCRIPTION OF THE EMBODIMENTS

The following describes embodiments of the present invention. Note that the present invention is not limited to the following description.

Objects of the present invention can be attained by a developing apparatus of the present invention using a developer amount controlling blade. To solve the foregoing problems, the developing apparatus of the present invention using the developer amount controlling blade has the following arrangement.

1. In a developing apparatus including a developer supporting body, which is elastic and provided so as to contact an image supporting body, and a developer amount controlling blade, which is provided so as to contact the developer supporting body, for controlling an amount of developer, the developer amount controlling blade has, at least in a region that contacts the toner, a composite plated film containing fine particles of fluorocarbon resin.

2. It is preferable that the fine particles of fluorocarbon resin has a diameter smaller than the thickness of the composite plated film.

3. It is preferable that the composite plated film is not thinner than 1 μm and not thicker than 15 μm.

4. In a developing apparatus including a developer supporting body, which is elastic and provided so as to contact an image supporting body, and a developer amount controlling blade, which is attached to the container so as to contact the developer supporting body, for controlling an amount of developer, the developer amount controlling blade has, at least in a region that contacts the toner, a composite plated film containing fine particles of fluorocarbon resin, the composite plated film satisfying the following conditions (a) to (c) and having excellent releasability:
(a) The composite plated film is not thinner than 1 μm and not thicker than 15 μm;
(b) The composite plated film contains fine particles of fluorocarbon resin, and the diameter of the fine particles of fluorocarbon resin is not smaller than 0.1 μm and not larger than 5 μm; and
(c) The fine particles of fluorocarbon resin in the composite plated film has a volume percentage not lower than 20% and not higher than 35%.

By covering the region where the surface of the developer amount controlling blade and the developer contact each other with the composite plate that satisfies the foregoing conditions (a) to (c), it is possible to prevent fixation of the toner to the developer amount controlling blade and to improve the resistance property of the developer amount controlling blade against melt and adhesion of the toner. As a result, it is possible to (i) form a thin layer of developer, which is required to develop high-quality images, or (ii) to prolong the life of the blade for forming images with toner having a low melting point.

5. The fine particles of fluorocarbon resin contained in the composite plated film of the developer amount controlling blade has a spherical shape.

Since the fine particles of fluorocarbon resin contained in the composite plated film of the developer amount controlling blade has a spherical shape, there is little friction at the time of forming the toner layer. Therefore, crush of the resin is unlikely to occur.

6. A container for containing a composite plating liquid used for forming the composite plated film has stirring means for keeping stirring the composite plated liquid.

By stirring the composite plating liquid, it is possible to evenly disperse the fine particles of fluorocarbon resin contained in the composite plating liquid. In this way, it is possible to form a uniform composite plated film.

7. At the end of the production process of the developer amount controlling blade, plating is performed.

In the case of transforming the developer amount controlling blade into an L-shape or the like, it is preferable to perform the plating after the transformation processing. This prevents the plated film from peeling off due to the stress applied at the time of the transformation processing.

8. The developer amount controlling blade is heat-processed after the composite plated film is formed on the surface thereof.

The composite plated film subjected to heat processing has excellent hardness and hydrophobicity. Therefore, it is possible to improve the resistance property of the developer amount controlling blade against melt and adhesion of the toner.

9. For the developing apparatus of the present invention using the developer amount controlling blade, non-magnetic single-component toner is used.

If magnetic toner is used, there is a possibility that, by the effect of electromagnetic force, the toner adheres to the developer amount controlling blade. On the other hand, non-magnetic single-component toner can mitigate the influence of the electromagnetic force and thereby reduce the possibility of melt and adhesion of the toner. In addition, color images can be developed with non-magnetic single-component toner.

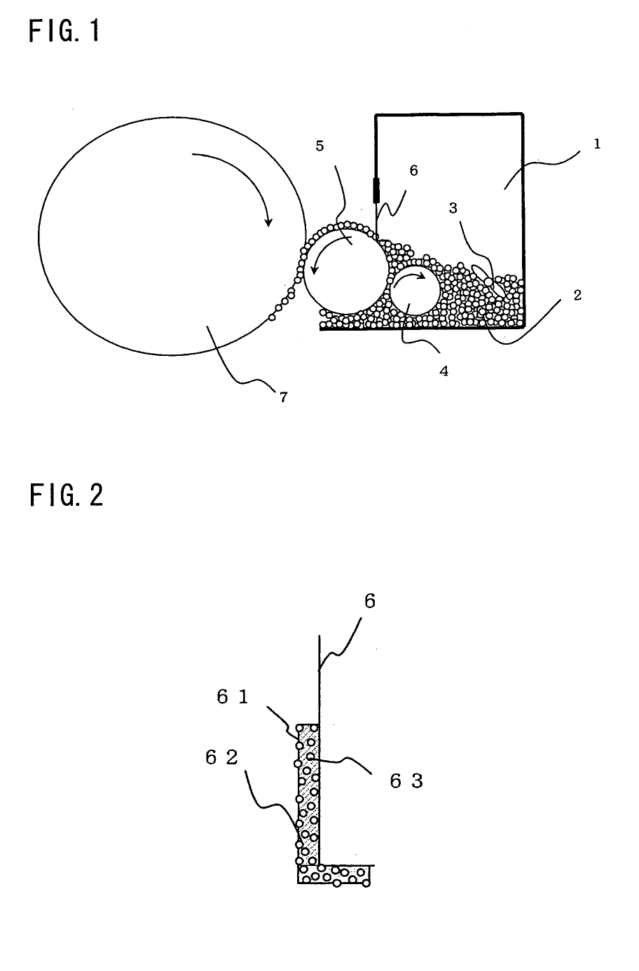

The following describes a preferred embodiment of the developing apparatus of the present invention using the developer amount controlling blade. FIG. 1 is a schematic cross-sectional view illustrating the developing apparatus of the embodiment of the present invention. The reference numeral 1 indicates a container, 2 indicates toner (developer), 3 indicates an agitator, 4 indicates a supply roller, 5 indicates a developing roller that is a toner supporting body (developer supporting body), 6 indicates a developer amount controlling blade, and 7 indicates an electrostatic latent image supporting body (image supporting body, also referred to as a photosensitive body).

In FIG. 1, the container 1 contains the toner 2, which is non-magnetic single-component toner. The toner 2 is conveyed by the agitator 3 to a toner storage section including the supply roller 4 and the developing roller 5, and supported on the surface of the developing roller 5. By the developer amount controlling blade 6, the toner 2 is shaped into an even and thin layer, and charged by friction so as to have a predetermined polarity. The toner layer formed on the surface of the developing roller 5 is carried to a developing region, where the photosensitive body 7, which supports an electrostatic latent image, and the developing roller 5 contact each other. In the developing region, the toner 2 electrostatically moves from the developing roller 5 to the photosensitive body 7, thereby visualizing the latent image. The non-magnetic single-component toner used in the developing apparatus of the present invention is formed by an ordinary crushing method or polymerization method, with no particular limitation.

FIG. 2 is an enlarged view illustrating the developer amount controlling blade 6. As shown in FIG. 2, in the region where the developer amount controlling blade 6 contacts the toner (in other words, in the region where the developer amount controlling blade 6 contacts the developing roller 5), a compound plated film 61 is formed.

The compound plated film 61 is provided between the developer amount controlling blade 6 and the developing roller 5, so as to prevent the toner from melting and adhering to the developer amount controlling blade 6.

The compound plated film 61 is provided on the surface of the developer amount controlling blade 6, which is a base material. In the compound plated film 61, matrix metal 62 contains fine particles of fluorocarbon resin 63 in a dispersed state. The compound plated film 61 may be provided in any region of the developer amount controlling blade 6, as long as a contact region, where the developer amount controlling blade 6 contacts the toner, is covered.

In the present invention, the developer amount controlling blade is usually a thin plate made of metal (e.g. stainless steel). It is preferable that the developer amount controlling blade has a thickness between 30 μm and 200 μm. If the thickness is less than 30 μm, the elasticity of the blade member becomes weak. This makes it difficult to evenly control the amount of developer. On the other hand, since the rigidity of the blade is usually proportional to the third power of the thickness of the plate, if the thickness is more than 200 μm, the rigidity becomes so strong that the developer amount controlling blade 6 cannot make a contact at an even contact pressure throughout a width of development.

The shape of the developer amount controlling blade is not particularly limited. In general, a flat plate or an L-shaped plate having one end bent is used as the developer amount controlling blade. Usually, the shape of the developer amount controlling blade is formed by punching or etching. Therefore, it is necessary to shape the blade before forming the plated film on the surface of a developer amount controlling blade having an L-shape, for example. On the other hand, if the blade is shaped into the L-shape after the plated film is formed, the shaped region is subjected to forcible and local bending stress. This results in crack or wreck of the plated film.

The plated film is formed on the base material by the following method, for example. In an ordinary plating process, the first step is defatting of the base material. Subsequently, the base material is cleaned with acid and then water. After that, the base material is plated. The base material is cleaned with water again, and dried as the last step. In the case of performing heat processing, the base material is heated thereafter for a certain period.

In general, the fluorocarbon resin contained in the plated film is, for example, polytetrafluoroethylene (hereinafter “PTFE”), tetrafluoroethylene -hexafluoropropylene copolymer (hereinafter “FEP”), tetrafluoroethylene-perfluoroalkylvinylether copolymer (hereinafter “PFA”), polychlorotrifluoroethylene (hereinafter “PCT-FE”), or tetrafluoroethylene-ethylene copolymer (hereinafter “ETFE”). By using these resin, it is possible to attain excellent characteristics such as self-lubricity, slidability (low friction), and non-adhesiveness. Among these resins, PTFE is preferable as the fluorocarbon resin contained in the plated film of the present invention, from the viewpoint of toner releasability and non-adhesiveness, for example.

The fluorocarbon resin used in the present invention is a known material, and the row material and production method thereof are not particularly limited. The fine particles of fluorocarbon resin used in the present invention have a spherical shape by emulsion, polymerization, or the like method. By using spherical resin particles in the compound plated film, it is possible to prevent the resin from being crushed by the stress of friction and the like.

In the present invention, the fluorocarbon resin may be of a single kind, or of more than one kinds. Even if more than one kinds of fluorocarbon resin are used, their mixing ratio may be determined arbitrarily, with no particular limitation.

By depositing the fine particles of fluorocarbon resin and the metal on the surface of the base material and thereby forming the composite plated film, it is possible to attain high toner releasability and low friction on a slide surface.

The matrix in the composite plated film contains nickel. Other metal, such as silver, copper, iron, zinc, tin, plumbum, cadmium, palladium, or noble metal may also be contained. A non-metallic element such as phosphorus or boron may also be contained.

If other metal is contained in the matrix, the ratio of the metal or non-metal in the composite plate is not particularly limited, as long as the effects of the present invention can be attained. Usually, the ratio of the metal or non-metal is not higher than 10% by weight and preferably not higher than 5% by weight, based on the total weight of the matrix in the composite plated film.

In order to form the composite plated film of the present invention, known methods (i.e. electroplating and electroless plating) that can deposit matrix metal containing nickel on the surface of the base material may be adopted. As the plating liquid, various plating liquids containing nickel and, if necessary, other metal or non-metal are known. Any plating liquid having a known composition may be used.

In the present invention, the diameter of the fine particles of fluorocarbon resin added to the plating liquid for forming the composite plated film (hereinafter “composite plating liquid”) is not particularly limited. However, it is preferable that the diameter of the fine particles of fluorocarbon resin is smaller than the thickness of the composite plated film. By using fine particles smaller than the thickness of the composite plated film, it is possible to reduce the possibility that the fine particles are separated from the plate surface due to friction and the like.

The thickness of the composite plated film of the present invention can be set appropriately in accordance with the material, shape, and the like of the base material. Usually, the thickness of the composite plated film is between 1 μm and 15 μm, preferably between 1 μm and 10 μm. If the thickness of the composite plated film is less than 1 μm, the plated film is so fragile that it will be worn or peeled off due to friction with the toner. If the thickness of the composite plated film is more than 15 μm, the blade is subjected to high stress. This increases the possibility that the plated film is peeled off.

Therefore, the diameter of the fine particles of fluorocarbon resin is determined by considering the thickness of the composite plated film. Usually, the diameter of the fine particles of fluorocarbon resin is between 0.1 μm and 5 μm, preferably between 0.2 μm and 1 μm. If the diameter of the fine particles is smaller than 0.1 μm, the surface of the plated film becomes flat and smooth. As a result, it is impossible to maintain the function of conveying and charging the toner. On the other hand, if the diameter of the fine particles is larger than 5 μm, there are such problems as insufficient dispersion of the fine particles in the plating liquid and separation of the particles from the plate surface.

The amount of the fine particles of fluorocarbon resin added to the composite plated film is, with no particular limitation, between 20% and 35% by volume percentage, preferably between 20% and 30% by volume percentage. If the ratio of the fine particles of resin is less than 20%, the toner releasability of the surface of the composite plated film becomes insufficient. This will result in adhesion, and eventually fixation, of the toner. If the ratio of the fine particles of resin is more than 35%, it means that a large amount of resin component is contained. This will cause the toner to be charged unevenly, and the plated layer and the base material will be less closely attached to each other.

The composite plating liquid for forming the composite plated film of the present invention needs to be such that fine particles of fluorocarbon resin having very high hydrophobicity are evenly dispersed and completely wet in a plating liquid. Therefore, a surface-active agent is usually used as the composite plating liquid. The surface-active agent may be, for example, a water-soluble cationic surface-active agent, a water-soluble nonionic surface-active agent, and a water-soluble amphoteric surface-active agent that shows cationic property at the pH value of the plating liquid.

In forming the composite plated film of the present invention, it is preferable to perform plating while stirring the composite plating liquid, so as to evenly disperse the fine particles of fluorocarbon resin. The stirring may be performed by ordinary mechanical stirring means, such as a screw or a magnetic stirrer, with no particular limitation.

Conditions for the plating may be determined appropriately in accordance with the material of the base material, the kind of the composite plating liquid, and the like. In general, the conditions for the plating may be selected from the liquid temperature, pH value, current density, and the like adopted in an ordinary composite plating method.

Note that it is not necessary to form the composite plated film of the present invention directly on the surface of the base material. The composite plated film may be formed after a known foundation plate layer is formed on the base material.

In another embodiment of the present invention, the composite plated film formed as described above is heat-processed. The heat processing is performed preferably at a temperature between 150° C. and 400° C., and more preferably between 200° C. and 400° C. If the heat processing is performed at a temperature lower than 150° C., heat must be applied for a long time in order to attain a desired effect. If the heat processing is performed at a temperature higher than 400° C., the properties of the fluorocarbon resin could be influenced.

The heat processing time is usually between ten minutes and 1.5 hour, preferably up to about one hour, although there is no particular limitation.

### EXAMPLES

The following specifically describes results of image formation performed by using the developer amount controlling blade.

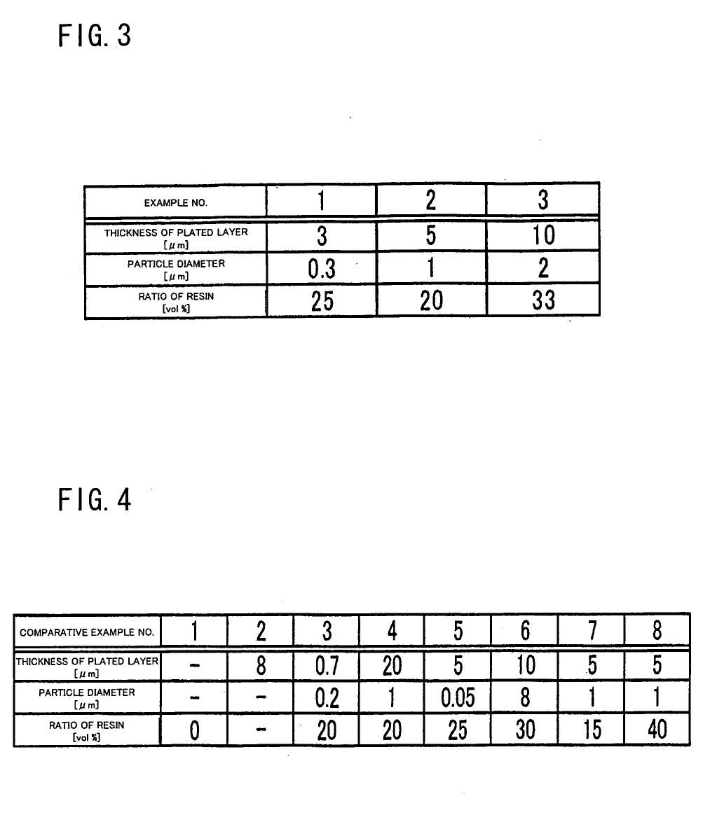

First, an example of a procedure for manufacturing the developer amount controlling blade is described. Using SUS304 (a product of Sohbi Kohgei Co., Ltd.) as a material of the blade member, punching was performed. In order to form a toner layer stably, a portion within 2 mm from the tip was bent into an L-shape. Then, a compound plated film containing fine particles of PTFE resin was formed by eutectoid. Conditions of the blade member used in EXAMPLES are shown in FIG. 3, and conditions of the blade member used in COMPARATIVE EXAMPLES are shown in FIG. 4. In EXAMPLE 2, heat processing was performed at 300° C. for one hour. In COMPARATIVE EXAMPLE 1, a SUS-only blade was used. In COMPARATIVE EXAMPLE 2, a PTFE resin film having a thickness of 8 μm was formed.

Then, with respect to the blades of EXAMPLES 1 to 3 and COMPARATIVE EXAMPLES 1 to 8, hydrophobicity was measured from an angle of contact with a 2 μl droplet by using an automatic angle of contact measure CA-V (a product of Kyowa Interface Science Co., Ltd.). The result was 47° in the case of SUS (COMPARATIVE EXAMPLE 1), and 110° to 135° in the case of blades of EXAMPLES and COMPARATIVE EXAMPLES including other film materials. Thus, it was found that high hydrophobicity was attained.

Next, running test was conducted by using developing apparatuses respectively including the blades of EXAMPLES and COMPARATIVE EXAMPLES. The following describes a procedure of the running test.

By using each developer amount controlling blade obtained by the foregoing production method, an AR-5030 developing apparatus (a product of Sharp Kabushiki Kaisha) was converted. Then, a long term running test using 40000 sheets of paper was conducted in an environment of constant temperature and constant pressure by using non-magnetic black toner having an 8.5 μm average volume particle diameter. Then, images, melt and adhesion of toner, and durability of the developer amount controlling blade were evaluated. The following more specifically describes the evaluation.

(A) Measurement of Image Density

The density of a 50 mm×50 mm solid image part was measured by a densitometer (RD-918, a product of Macbeth).

(B) Measurement of Charge Amount/Traveling Amount

By a suction method, counter charge at the time of suction of the toner on the developer supporting body was measured, and the charge amount and traveling amount of the toner were calculated based on the sucked mass.

(C) Melt and Adhesion Test

By printing an entirely solid image on an A4 paper (210.3 mm×297.0 mm), appearance of white lines was tested. Meanwhile, the toner on the developer supporting body was put on a tape, and appearance of lines was tested.

Then, the developer supporting body was detached, and the toner on the developer amount controlling blade was blown by a blower. After that, the developer amount controlling blade was visually observed by an optical microscope.

As evaluations of the foregoing three items, “C” indicates that melt and adhesion was found, “B” indicates that melt and adhesion of the toner was found on the blade and lines were found only on the developer supporting body, and “A” indicates that no melt and adhesion of the toner was found on the blade and no white line was found on the solid image on the developer supporting body.

(D) Durability of Blade

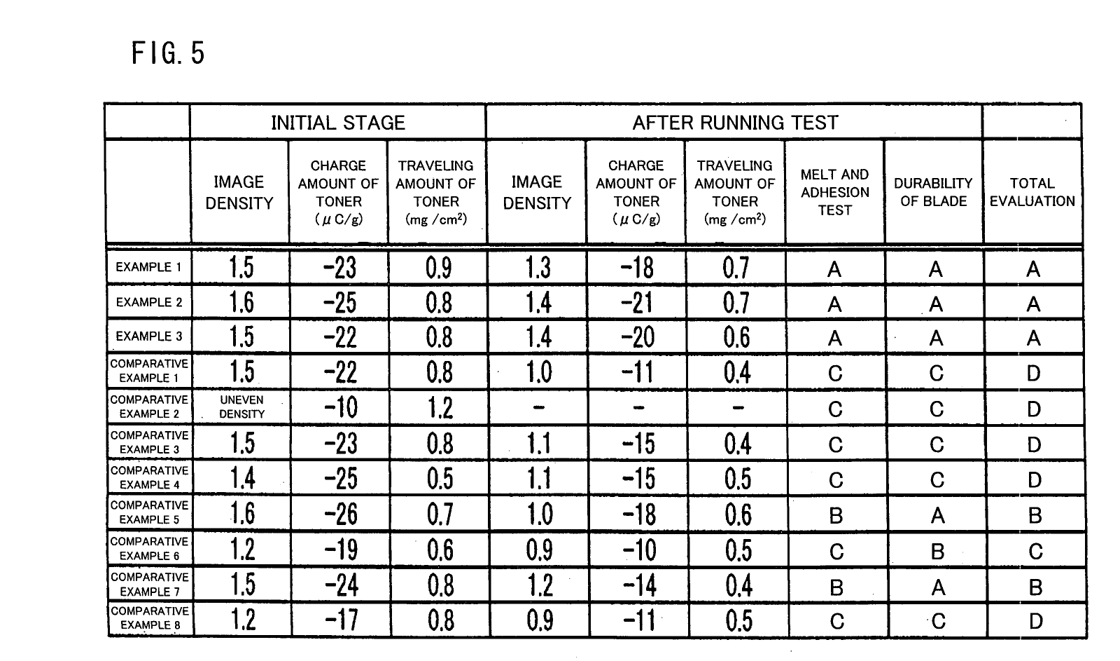

After the running test, the tip of the blade was observed by the optical microscope so as to see whether or not there was any missing or worn part. “A” indicates that there was almost no change; “B” indicates that there were some missing or worn parts; and “C” indicates that there were missing or worn parts. The results of evaluation are shown in FIG. 5.

In the case where the developer amount controlling blade of COMPARATIVE EXAMPLE 2 was used, many initial images were so uneven in density that it was impossible to measure the density. In addition, the PTFE resin was so worn and the amount of melt and adhesion of the toner was so large as to create white lines (white, line-shaped unevenness) that it was impossible to measure the charge amount and traveling amount of the toner on the developer supporting body correctly.

In COMPARATIVE EXAMPLES 3 and 4, the plated film was worn and peeled off. In COMPARATIVE EXAMPLE 6, the PTFE resin was separated from the surface of the plate by friction. In COMPARATIVE EXAMPLE 8, the plated film was partially worn or peeled off because the plated layer and the base material were not closely attached to each other sufficiently.

As a total evaluation of EXAMPLES 1 to 3 and COMPARATIVE EXAMPLES 1 to 8, EXAMPLES 1 to 3 were all “A”, while COMPARATIVE EXAMPLES were “B” to “D”. Thus, good results were obtained in EXAMPLES 1 to 3.

The indicators A, B, C, and D used in this total evaluation are defined as follows:

A: After the running test, neither melt and adhesion of the toner nor white lines were found on the image, blade, and developer supporting body, and the surface of the blade was not worn out or deteriorated.

B: After the running test, melt and adhesion of the toner or white lines were found on the blade or developing supporting body. There was also a change (e.g. the plate on the surface of the blade was peeled off) that could be considered as wearing out or deterioration of the surface of the blade.

C: Although the durability of the blade was slightly improved as compared to the conventional arrangement, melt and adhesion of the toner was found on the image, and the surface of the blade was worn out or deteriorated.

D: The resistance property against melt and adhesion of the toner and the durability of the blade were no better than those of a case where the plating in accordance with the present invention was not performed.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

1. A developing apparatus, comprising:
a container for containing developer including toner;
a developer supporting body, which is elastic and provided so as to contact an image supporting body, for supplying the developer to the image supporting body; and
a developer amount controlling blade, which is attached to the container so as to contact the developer supporting body, for controlling an amount of developer supplied,
the developer amount controlling blade having, at least in a region that contacts the toner, a composite plated film containing fine particles of fluorocarbon resin.

2. The developing apparatus as set forth in claim 1, wherein:
the composite plated film is not thinner than 1 μm and not thicker than 15 μm.

3. The developing apparatus as set forth in claim 2, wherein:
the fine particles of fluorocarbon resin has a diameter smaller than a thickness of the composite plated film.

4. The developing apparatus as set forth in claim 1, wherein:
the composite plated film satisfies the following conditions (a) to (c):
(a) The composite plated film is not thinner than 1 μm and not thicker than 15 μm;
(b) The fine particles of fluorocarbon resin has a diameter not smaller than 0.1 μm and not larger than 5 μm; and
(c) The fine particles of fluorocarbon resin in the composite plated film has a volume percentage of not lower than 20% and not higher than 35%.

5. The developing apparatus as set forth in claim 1, wherein:
the fine particles of fluorocarbon resin contained in the composite plated film have a spherical shape.

6. The developing apparatus as set forth in claim 1, wherein:
the composite plated film is formed by keeping stirring a composite plating liquid.

7. The developing apparatus as set forth in claim 1, wherein:
the developer amount controlling blade is plated at an end of a manufacturing process.

8. The developing apparatus as set forth in claim 1, wherein:
the developer amount controlling blade is heat-processed after the composite plated film is formed on a surface thereof.

9. The developing apparatus as set forth in claim 1, wherein:
the toner is non-magnetic single-component toner.
